(19) United States
(12) Patent Application Publication
(10) Pub. No.: US 2010/0208116 A1
(43) Pub. Date: Aug. 19, 2010

(54) COLOR CCD LINEAR IMAGE SENSOR

(75) Inventor: Takashi IIJIMA, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/707,378

(22) Filed: Feb. 17, 2010

(30) Foreign Application Priority Data
Feb. 18, 2009 (JP) 2009-035573

(51) Int. Cl. H04N 5/335

(52) U.S. Cl. 348/311; 348/E05.091

(57) ABSTRACT

A color CCD linear image sensor has: first basic pixels arranged in a first column and configured to accumulate first-column pixel charges; and second basic pixels arranged in a second column adjacent to the first column and configured to add accumulated charges to the first-column pixel charges to generate second-column pixel charges. The first basic pixels include a first-column first-color pixel, a first-column second-color pixel adjacent to the first-column first-color pixel, and a first-column third-color pixel adjacent to the first-column second-color pixel. The second basic pixels include a second-column first-color pixel, a second-column second-color pixel adjacent to the second-column first-color pixel, and a second-column third-color pixel adjacent to the second-column second-color pixel. The second-column first-color pixel is arranged adjacent to the first-column second-color pixel.

### INCORPORATION BY REFERENCE

This application is based upon and claims the benefit of priority from Japanese patent application No. 2009-035573, filed on Feb. 18, 2009, the disclosure of which is incorporated herein in its entirety by reference.

### BACKGROUND OF THE INVENTION

1. Field of the Invention

The present invention relates to a color CCD linear image sensor.

2. Description of Related Art

In recent years, a scanner as a peripheral device of a personal computer is widely spread, and improvement in performance of a copier is required. Consequently, demand for a color CCD linear image sensor to read a color image is increasing. Such the color CCD linear image sensor includes: a light receiving part that is provided with a photodiode; a gate part that uses a read pulse to read signal charges generated in the light receiving part; a signal charge transfer part; and an output part that is connected to an external signal processing circuit. The signal charge transfer part includes, for example, a two-phase driven CCD shift register.

FIG. 1 is a block diagram illustrating a configuration of a typical color CCD linear image sensor 101. The color CCD linear image sensor 101 includes light receiving parts (a first light receiving part 102a, a second light receiving part 102b, and a third light receiving part 102c) respectively provided with RGB color filters.

The first light receiving part 102a has a photodiode structure. The first light receiving part 102a performs photoelectric conversion to generate signal charges, and supplies the signal charges to a first signal charge transfer part 103a (in a direction indicated by an arrow in the diagram) through a signal reading part (not illustrated) in response to a read pulse. Similarly, the second light receiving part 102b supplies signal charges to a second signal charge transfer part 103b in response to a read pulse, and the third light receiving part 102c supplies signal charges to a third signal charge transfer part 103c in response to a read pulse.

In the color CCD linear image sensor 101, each of the first, second and third signal charge transfer parts 103a, 103b and 103c includes a two-phase driven CCD shift register. The first signal charge transfer part 103a is supplied with clocks φ1 and φ2 for driving the two-phase driven CCD shift register through first transfer electrode terminals 106a. Similarly, the second signal charge transfer part 103b is supplied with the clocks φ1 and φ2 from second transfer electrode terminals 106b, and the third signal charge transfer part 103c is supplied with the clocks φ1 and φ2 from third transfer electrode terminals 106c.

The signal charges transferred by the first signal charge transfer part 103a are supplied to a first output part 104a. The first output part 104a is formed of a floating diffusion region, and includes: a signal charge detecting part that converts the signal charges into a signal voltage and amplifies the signal voltage; and analog circuits such as a source follower and an inverter. The first output part 104a is connected to an external signal processing circuit (not illustrated). The external signal processing circuit generates a color image on the basis of the signal voltage supplied from the color CCD linear image sensor 101.

Similarly, the signal charges transferred by the second signal charge transfer part 103b are supplied to a second output part 104b, and the signal charges transferred by the third signal charge transfer part 103c are supplied to a third output part 104c. As in the case of the first output part 104a, each of the second and third output parts 104b and 104c converts the signal charges into a signal voltage, amplifies the signal voltage and supplies the amplified signal voltage to an external signal processing circuit.

FIG. 2 is a block diagram exemplifying another configuration of a typical color CCD linear image sensor. The color CCD linear image sensor 201 illustrated in FIG. 2 employs a dot sequential color method. The color CCD linear image sensor 201 includes: only one light receiving part 202 (sensor column) in dot sequential arrangement; one signal charge transfer part 203 including CCD registers for respective colors of R, G and B; and one output part 204. On the light receiving part 202, a color filter including a plurality of RGB basic units 207 is formed. The color CCD linear image sensor 201 obtains signal charges from the one output part 204. For this reason, the difference in characteristics of output circuits for the respective color outputs (first, second and third output parts 104a, 104b and 104c) as in the above-described color CCD linear image sensor 101 is not caused. Therefore, linear properties of the respective color outputs are equalized.

As a technique for improving characteristics of the above-described color CCD linear image sensor 101 or 201, such as a scanning rate, sensitivity and an SN (signal-to-noise) ratio, there is known a TDI (Time Delay Integration) method (see, for example, Japanese Patent Publication JP-H08-18867 (Patent document 1)). FIG. 3A is a plan view illustrating a configuration of a TDI-based CCD linear sensor 380 described in the Patent document 1. In the CCD linear sensor 380, a plurality of (n) pixel columns 381 are parallel arranged. In each of the plurality of pixel columns 381, there are linearly arranged a plurality of (m) pixels 381a, each of which includes a photodiode or the like that, upon receipt of incident light, converts the light into electrons on the basis of photoelectric conversion.

Each of the pixel columns has a transfer electrode 383 arranged parallel to the pixel column to provide a structure in which the pixel columns and the transfer electrodes are alternately arranged. Focusing on a transfer electrode in the k-th column (1≦k≦n−1) among the transfer electrodes, the transfer electrode transfers charges from a pixel in the i-th row (1≦i≦m) of the k-th pixel column adjacent on the left side of the electrode to a pixel in the i-th row of the (k+1)-th pixel column adjacent on the right side of the electrode in the diagram.

We hereinafter denote a pixel in the i-th row and the j-th column (1≦j≦n) by a pixel (i, j). In the TDI-based CCD linear sensor, the signal charges generated in a pixel (1, 1) is transferred to a pixel (1, 2) through the transfer electrode 383 in the first column; then sequentially transferred to pixels (1, 3), (1, 4), . . . , (1, n−1), to (1, n), and further transferred to a CCD register 385 through a signal charge transfer part 384. Subsequently, the signal charges are transferred from the CCD register 385 to an output part 386, where the signal charges are converted into an appropriate output signal, which is then outputted.

When an image is scanned by the TDI method, the image moves on the sensor in a direction (A) perpendicular to the pixel column. At this time, a charge transfer rate between pixel columns is synchronized with a scanning rate of the image on the sensor, and the signal charges associated with an image is added with the corresponding signal charges in a pixel constantly irradiated with the same image. That is, at a time when signal charges generated in a pixel in the first column by incident light from a specific image portion are transferred to the adjacent pixel in the second-column, the incident light having generated the signal charges is irradiated on the pixel in the second-column, and signal charges generated here in the second-column by the incident light are added to the transferred signal charges that was generated in the pixel in the first-column. A total area of pixels that generate the signal charges in response to the incident light from some image portion corresponds to n pixels in total, and therefore high sensitivity can be obtained.

FIG. 3B is a plan view illustrating another configuration of the TDI-based CCD linear sensor described in the Patent document 1. In a color CCD linear image sensor 311, there are parallel arranged a plurality of pixel columns 301-1, 301-2, . . . , 301-(n−1) and 301-n in each of which pixels 301a are linearly arranged, and an interval between the pixel columns is twice as long as a scanning pitch in a direction orthogonal to the pixel columns. Moreover, an accumulation part 302 that can temporarily accumulate signal charges and a transfer electrode 303 are provided between any adjacent pixel columns.

In the color CCD linear image sensor 311 shown in FIG. 3B, the distance between the pixel columns is set to N times the scanning pitch, and an amount equal to the scanning pitch is ensured for a width of the pixel. For this reason, even if the scanning pitch is reduced, a sufficient pixel effective area can be obtained. Also, the transfer part arranged between the pixel columns is provided with the accumulation part together. This enables signal charges generated by incident light from a specific image portion to be transferred and simultaneously sequentially added. As described, the color CCD linear image sensor 311 can obtain high sensitivity and a sufficient saturated charge amount.

FIG. 4 is a plan view illustrating an entire configuration of the typical color CCD linear sensor exemplified in FIG. 3A or 3B. The color CCD linear sensor 321 includes three TDI-based CCD linear sensors in order to achieve colorization. The color CCD linear image sensor 321 includes a plurality of light receiving parts (a first light receiving part 322a, a second light receiving part 322b, and a third light receiving part 322c) respectively provided with RGB color filters.

The first light receiving part 322a is supplied with transfer clocks φA and φB through first drive clock supply terminals 325a. Similarly, the second light receiving part 322b is supplied with the transfer clocks φA and φB through second drive clock supply terminals 325b, and the third light receiving part 322c is supplied with transfer clocks φA and φB through third drive clock supply terminals 325c.

Each of the light receiving parts (the first light receiving part 322a, the second light receiving part 322b, and the third light receiving part 322c) transfers signal charges for one pixel in synchronization with a scanning rate (period) in a direction indicated by an arrow illustrated in FIG. 4, and while adding the signal charges, reads the signal charges to a signal charge transfer part (a first signal charge transfer part 323a, a second signal charge transfer part 323b, a third signal charge transfer part 323c). Each of the signal charge transfer parts (the first signal charge transfer part 323a, the second signal charge transfer part 323b, and the third signal charge transfer part 323c) receives the clocks φ1 and φ2 from each of transfer electrode terminals (a first transfer electrode terminal 326a, a second transfer electrode terminal 326b, and a third transfer electrode terminal 326c). In response to the clocks φ1 and φ2, each of the signal charge transfer parts (a first signal charge transfer part 323a, a second signal charge transfer part 323b, and a third signal charge transfer part 323c) transfers the signal charges to each of output parts (a first output part 324a, a second output part 324b, and a third output parts 324c). The color CCD linear image sensor 321 accumulates (adds) signal charges for a same position through the plurality of lines to thereby improve sensitivity with keeping resolution.

Also, there is known a technique related to the TDI-based CCD linear image sensor whose configuration is different from that of the CCD linear sensor described in the above Patent document 1 (see, for example, Japanese Patent Publication JP-2001-532652 (Patent document 2)). Patent document 2 describes a technique for solving a problem that ultraviolet region sensitivity of the TDI-based CCD linear image sensor is low. FIG. 5A is a plan view illustrating a configuration of a color CCD linear image sensor 401 described in the Patent document 2. The color CCD linear image sensor 401 discloses a TDI-based CCD linear image sensor that can improve the ultraviolet region sensitivity for use as an UV (ultraviolet) inspector.

Regarding a light receiving cell 412 serving as a unit pixel on a light receiving surface 410, four light receiving cells separated by a channel stop 414 are configured as one set in which two cells are arranged in a horizontal direction and two cells are arranged in a vertical direction. Sets of the light receiving cells 412 are arranged in the horizontal direction at intervals of an integral multiple of one pixel (in the diagram, four pixels), and in the vertical direction at intervals of the predetermined number of rows (e.g., 10 rows) with being displaced one pixel by one pixel. Also, the color CCD linear image sensor 401 includes a horizontal transfer part 420, and an amplifier 421 that amplifies an obtained signal charge. A region excluding the light receiving cells 412 on the light receiving surface 410 includes a vertical transfer part 413, and as a whole of the light receiving part 410, a signal charge generated in the light receiving cells 412 is transferred in a direction indicated by an arrow OPV of the diagram.

FIG. 5B is a plan view enlarging a part of the light receiving cells and vertical transfer part in FIG. 5A. Four light receiving cells C1, C2, C3 and C4 in the diagram are arranged at a same horizontal position, and respectively image a same part of a subject. In the vertical transfer part 413, one transfer cell is formed of three phases, i.e., first, second and third phases 413a, 413b and 413c, and repeatedly arranged in substantially the same direction as the arrow OPV.

We have now discovered the following points. The color CCD linear image sensor 101 illustrated in FIG. 1 has a disadvantage that RGB line intervals L are required in the scanning direction, and therefore a chip size is increased. In the case of requiring the line intervals, it is necessary to externally store color information of lines such as the first and second lines and the second and third lines until the completion of scanning and then perform signal processing with the three color information. For this reason, an external memory having a considerably large capacity is required.

In the color CCD linear image sensor 201 illustrated in FIG. 2, three pixels for RGB constitute one unit, and therefore a pixel size in the horizontal direction is decreased, resulting in a reduction in sensitivity. Also, in order to increase the sensitivity, the number of light receiving surfaces should be increased in the horizontal direction, and therefore a chip size is increased.

The color CCD linear image sensor 201 does not require the line interval L, and therefore the chip size in the vertical direction may be reduced; however, there is a disadvantage of low sensitivity because the three pixels for RGB constitutes the one unit. Further, single color pixels are adjacent to each other, and therefore when a manuscript having a vertically striped pattern around a limit of resolution is scanned, an optical low pass filter is required to prevent aliasing. Consequently, in the color CCD linear image sensor 201, it is difficult to decrease a size and achieve both a reduction in manufacturing cost and improvement in output sensitivity without use of the optical low pass filter.

In a color CCD linear image sensor based on the TDI method such as the color CCD linear image sensor 321 illustrated in FIG. 4, each of the RGB light receiving parts (the first light receiving part 322a, the second light receiving part 322b, and the third light receiving part 322c) has a plurality of stages of pixels in the scanning direction, which requires regions for the RGB line intervals L, and therefore there is a disadvantage of an increase in a chip size. Further, as the number of pixels is increased in the scanning direction to improve sensitivity, the RGB line interval is increased, and therefore it is difficult to decrease the size.

In the color CCD linear image sensor 401 illustrated in FIG. 5A (or FIG. 5B), the transfer part that reads signal charges from a pixel in the horizontal direction adds signal charges of pixels in the same scanning direction. For this reason, an area should be increased in both of the horizontal and scanning directions, which makes it difficult to decrease a device size. Consequently, there arises a problem of reduction in yield in a manufacturing process.

### SUMMARY

In one embodiment of the present invention, a color CCD linear image sensor is provided. The color CCD linear image sensor comprises: a light receiving part configured to accumulate charges in response to light irradiated; and a signal charge transfer part configured to read the charges accumulated in the light receiving part and transfer the charges to an output part. The light receiving part comprises: a plurality of first basic pixels arranged in a first-column and configured to accumulate first-column pixel charges; and a plurality of second basic pixels arranged in a second-column adjacent to the first-column and configured to add charges accumulated in response to the light to the first-column pixel charges to generate second-column pixel charges. The plurality of first basic pixels comprises: a first-column first-color pixel configured to generate first-column first-color charges associated with a first color; a first-column second-color pixel arranged adjacent to the first-column first-color pixel and configured to generate first-column second-color charges associated with a second color; and a first-column third-color pixel arranged adjacent to the first-column second-color pixel and configured to generate first-column third-color charges associated with a third color. The plurality of second basic pixels comprises: a second-column first-color pixel configured to generate second-column first-color charges associated with the first color; a second-column second-color pixel arranged adjacent to the second-column first-color pixel and configured to generate second-column second-color charges associated with the second color; and a second-column third-color pixel arranged adjacent to the second-column second-color pixel and configured to generate second-column third-color charges associated with the third color. The second-column first-color pixel is arranged adjacent to the first-column second-color pixel.

According to the present invention, it is possible to improve output sensitivity of the color CCD linear image sensor and to achieve reduction in the sensor size.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram illustrating a configuration of a typical color CCD linear image sensor;

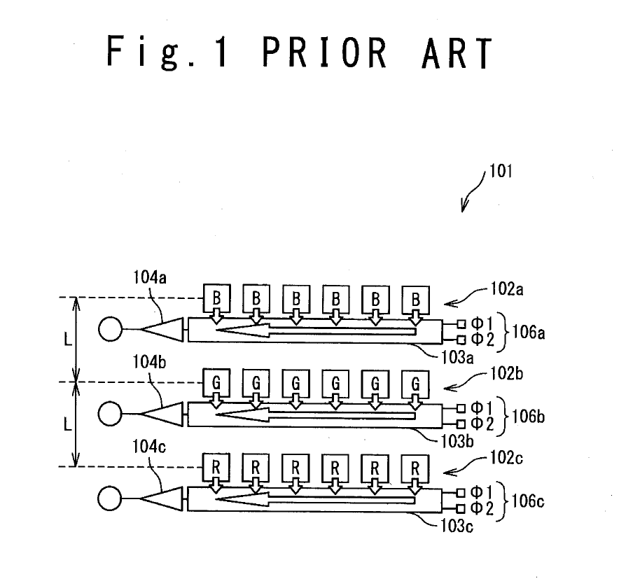

FIG. 2 is a block diagram exemplifying another configuration of the typical color CCD linear image sensor;

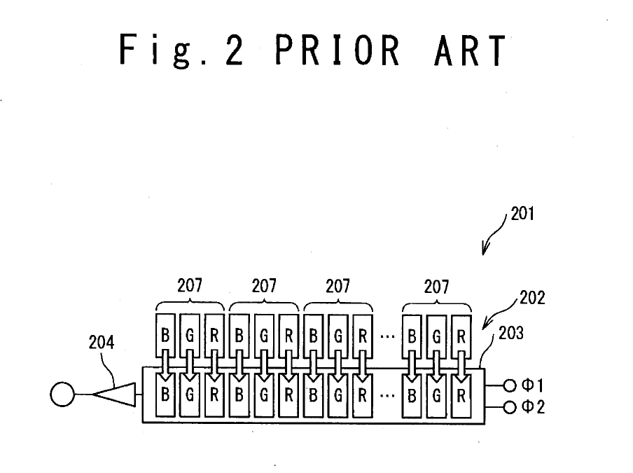

FIG. 3A is a plan view illustrating a configuration of a TDI-based CCD linear image sensor;

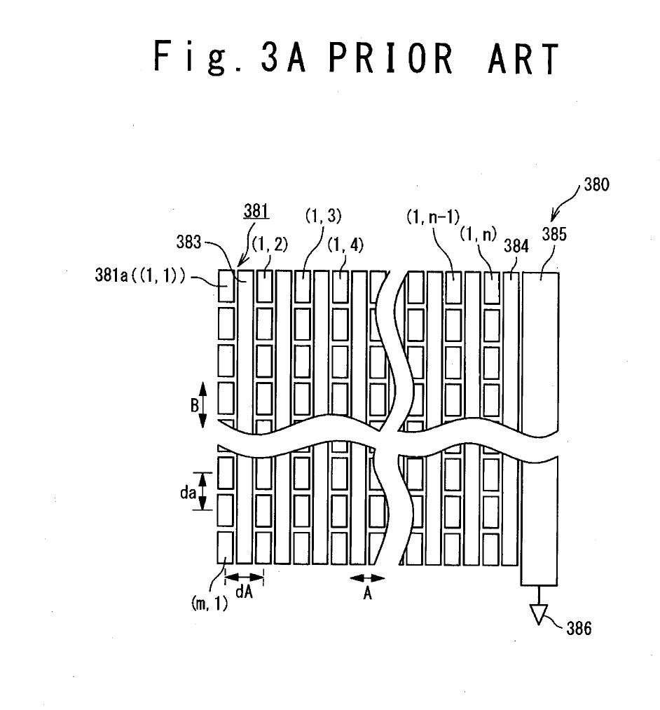

FIG. 3B is a plan view illustrating another configuration of a TDI-based CCD linear image sensor;

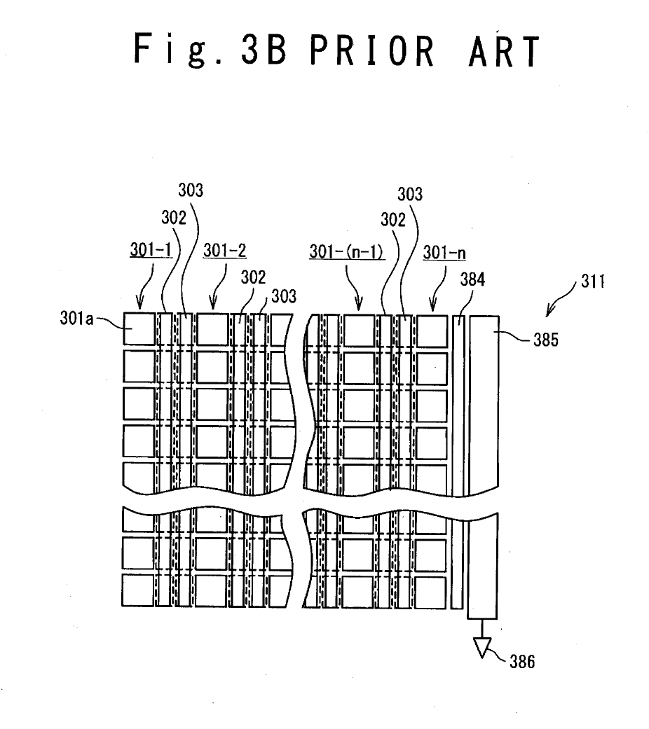

FIG. 4 is a plan view illustrating an entire configuration of a typical color CCD linear image sensor;

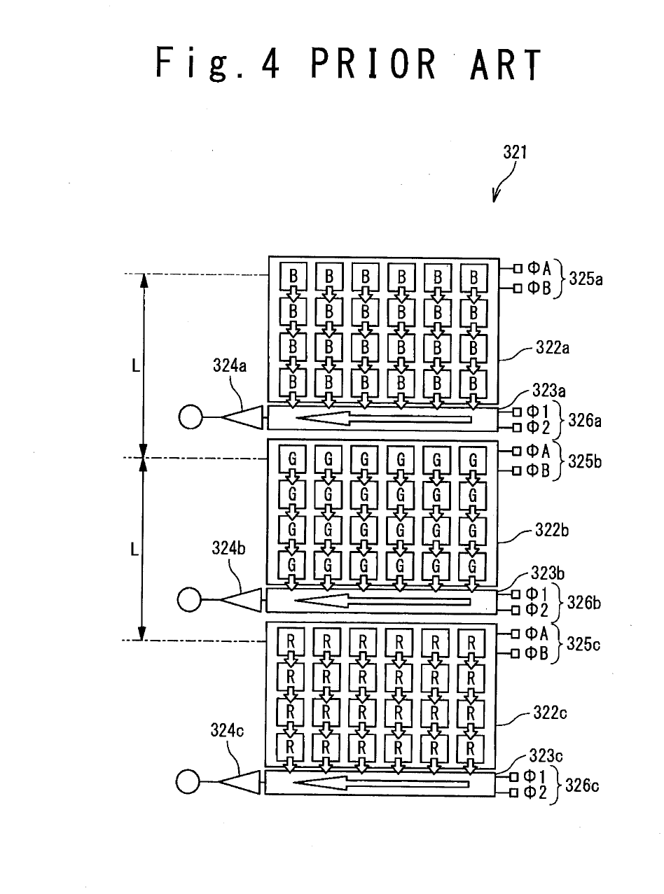

FIG. 5A is a plan view illustrating a configuration of a typical color CCD linear image sensor;

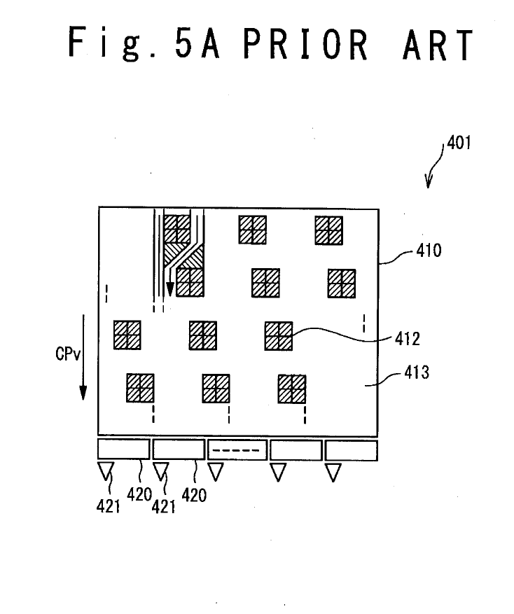

FIG. 5B is a plan view enlarging a part of a vertical transfer part of the typical color CCD linear image sensor;

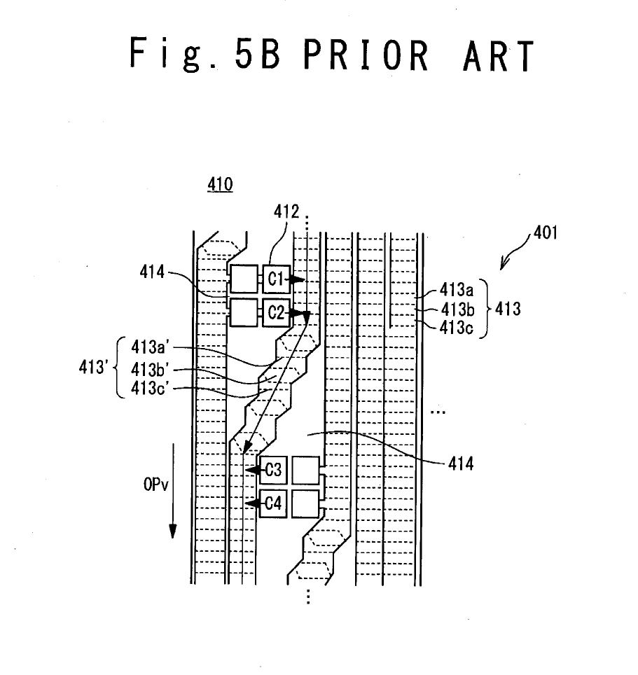

FIG. 6 is a plan view exemplifying a configuration of a color CCD linear image sensor 1 according to a first embodiment;

FIG. 7 is a plan view exemplifying operation of the color CCD linear image sensor 1 according to the present embodiment;

FIG. 8 is a plan view exemplifying a configuration of an effective aperture 17 of the color CCD linear image sensor 1 according to the present embodiment;

FIG. 9A is a graph exemplifying space frequency dependence of MTF;

FIG. 9B is a graph exemplifying an appearance of loopback distortion;

FIG. 9C is a graph exemplifying interpretation of the loopback distortion with use of a space frequency;

FIG. 10 is a plan view exemplifying a specific configuration of the color CCD linear image sensor 1 according to the first embodiment; and

FIG. 11 is a plan view exemplifying a configuration of a color CCD linear image sensor 1 according to a second embodiment of the present invention.

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

An embodiment of the present invention is described below on the basis of the drawings. Note that in the diagrams for describing the embodiment, the same member is denoted by the same reference numeral in principle, and redundant description thereof is omitted.

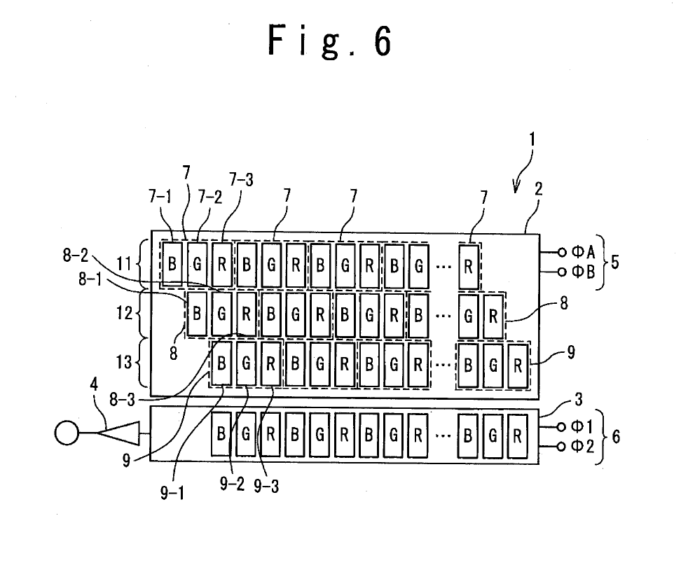

FIG. 6 is a plan view exemplifying a configuration of a color CCD linear image sensor 1 according to a first embodiment. The color CCD linear image sensor 1 includes a light receiving part 2, a charge transfer part 3 and an output part 4. The light receiving part 2 is connected to drive clock supply terminals 5 that supply a light receiving part first clock φA and a light receiving part second clock φB. The charge transfer part 3 is connected to transfer clock supply terminals 6 that supply a CCD first clock φ1 and a CCD second clock φ2.

The light receiving part 2 includes a first pixel column 11, a second pixel column 12 and a third pixel column 13. In the first pixel column 11, a plurality of first-column basic pixel units 7 are arranged. Each of the plurality of first-column basic pixel units 7 includes a first-column blue pixel 7-1, a first-column green pixel 7-2 and a first-column red pixel 7-3. In the second pixel column 12, a plurality of second-column basic pixel units 8 are arranged. Each of the plurality of second-column basic pixel units 8 includes a second-column blue pixel 8-1, a second-column green pixel 8-2 and a second-column red pixel 8-3. In the third pixel column 13, a plurality of third-column basic pixel units 9 are arranged. Each of the plurality of third-column basic pixel units 9 includes a third-column blue pixel 9-1, a third-column green pixel 9-2 and a third-column red pixel 9-3.

The charge transfer part 3 includes a two-phase driven CCD that operates in response to the CCD first clock φ1 and the CCD second clock φ2. The charge transfer part 3 is supplied with the CCD first clock φ1 and the CCD second clock φ2 for driving the two-phase driven CCD through the transfer clock supply terminals 6. Signal charges transferred by the charge transfer part 3 are supplied to the output part 4. The output part 4 is formed of a floating diffusion region, and includes: a signal charge detecting part that converts the signal charges into a signal voltage and amplifies the signal voltage; and analog circuits such as a source follower and an inverter. The output part 4 is connected to an external signal processing circuit (not illustrated). The external signal processing circuit generates a color image on the basis of the signal voltage supplied from the color CCD linear image sensor 1.

Referring to FIG. 6, the light receiving part 2 has a TDI-based configuration in which a unit pixel (e.g., color filter for RGB three primary colors performing color reproduction processing is formed on the pixel) is repeatedly arranged in a horizontal direction, and a plurality of pixel stages each having the same number of unit pixels are arranged in a scanning direction (vertical direction) with being displaced one pixel by one pixel to add and read the signal charges.

The light receiving part 2 supplies the two-phase transfer clocks (the light receiving part first clock φA and the light receiving part second clock φB) to a transparent electrode formed of, for example, polysilicon through the drive clock supply terminals 5, and transfers signal charges to the last RGB light receiving part line while adding the signal charges. The charge transfer part 3 is configured to face to the last RGB light receiving part line. The charge transfer part 3 reads the signal charges in the last RGB light receiving part line through a signal reading part (not illustrated) that operates in response to a read pulse.

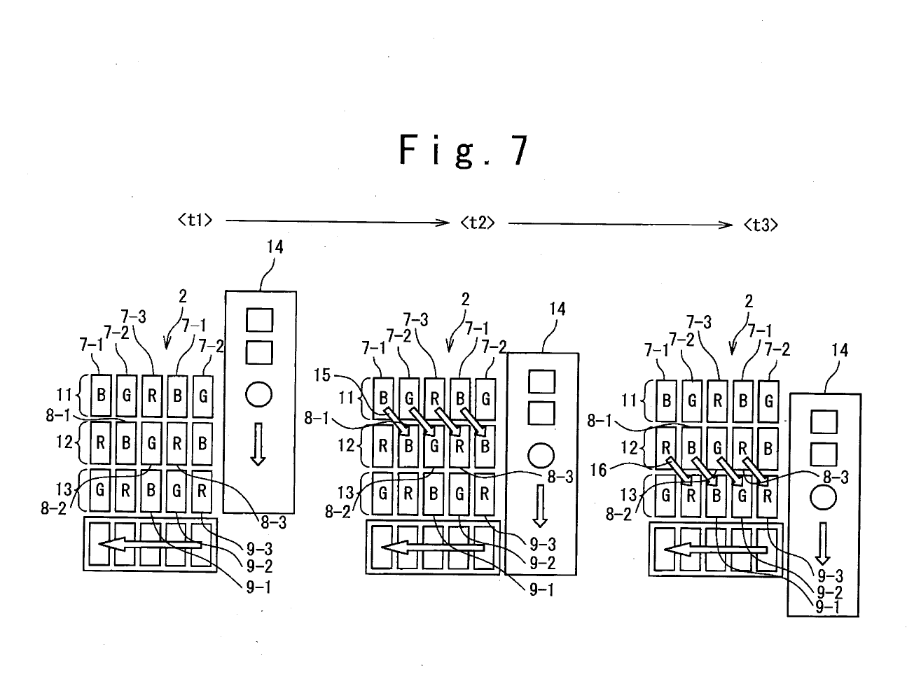

FIG. 7 is a plan view exemplifying operation of the color CCD linear image sensor 1 of the present embodiment. FIG. 7 exemplifies the operation for the case where an image of a manuscript 14 is scanned in a scanning direction in the order of time t1, t2 and t3. At the time t1, signal charges are accumulated in the light receiving part at the corresponding accumulation position (11). Then, in synchronization with the scanning direction, at time t2, signal charges are accumulated in the light receiving part at the corresponding accumulation position (12). Subsequently, at time t3, signal charges are accumulated in the light receiving part at the corresponding accumulation position (13). The signal charges for one pixel at the respective accumulation positions are transferred and added along signal charge moving paths 15 and 16 in synchronization with the scanning rate (period).

In the conventional TDI method intended to improve sensitivity of the CCD linear image sensor, a plurality of stages of light receiving parts forming the same color are provided, and therefore a line interval is required to thereby increase a chip size, which makes it difficult to reduce a device size. According to the color CCD linear image sensor 1 of the present embodiment, the plurality of stages of the pixel arrangements in the light receiving part in each of which the single basic pixel (e.g., RGB) is repeatedly arranged in the horizontal direction are arranged in the scanning direction with being obliquely displaced one pixel by one pixel, which can reduce the line interval. The signal charges of pixels for the same color are added and transferred, and thus the sensitivity can be improved.

Moreover, apertures of pixels for the same color in the horizontal direction serve as an effective aperture, which serves as like an optical low pass filter, and therefore no optical low pass filter is required. For this reason, improvement in the output sensitivity and reduction in the chip size can be both achieved, and therefore cost can be reduced.

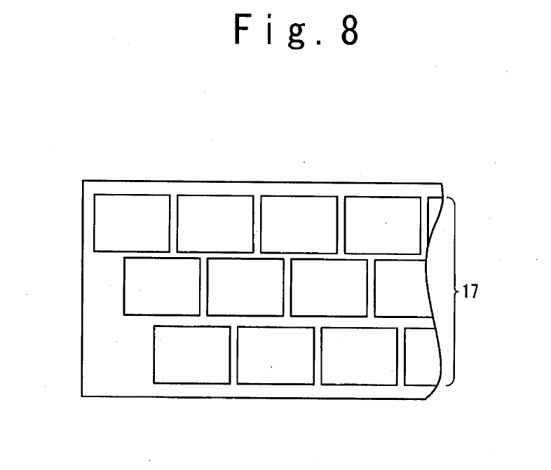

FIG. 8 is a plan view exemplifying a configuration of an effective aperture (hereinafter referred to as an effective aperture 17) of the color CCD linear image sensor 1 according to the present embodiment. In the color CCD linear image sensor 1 of the present embodiment, signals of the light receiving parts displaced in the horizontal direction one pixel by one pixel are added for three pixels. Based on such configuration and operation, apertures of three pixels in the horizontal direction can form the effective aperture 17. This produces an effect similar to an effect of the optical low pass filter, and therefore the color CCD linear image sensor 1 according to the present embodiment does not require the optical low pass filter. Accordingly, improvement in the sensitivity and reduction in the chip size can be both achieved.

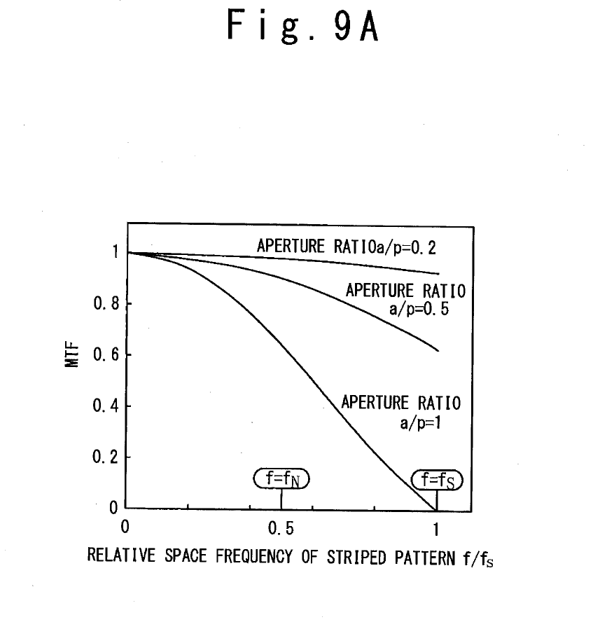

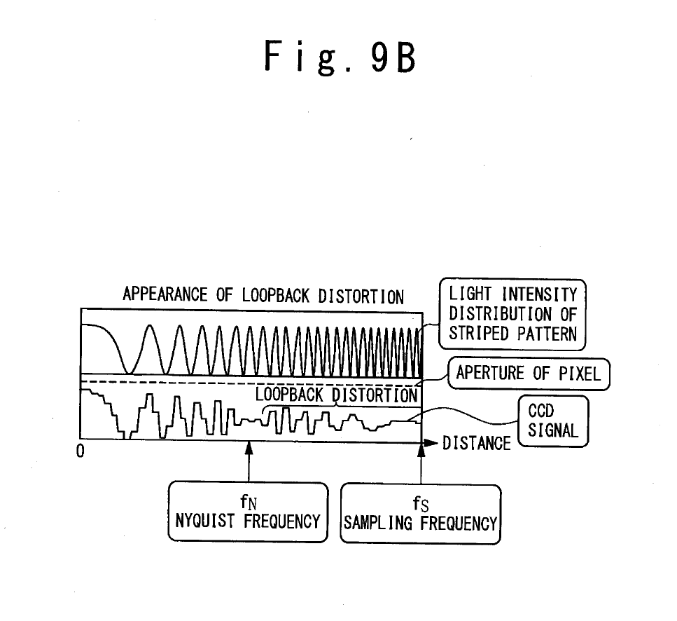

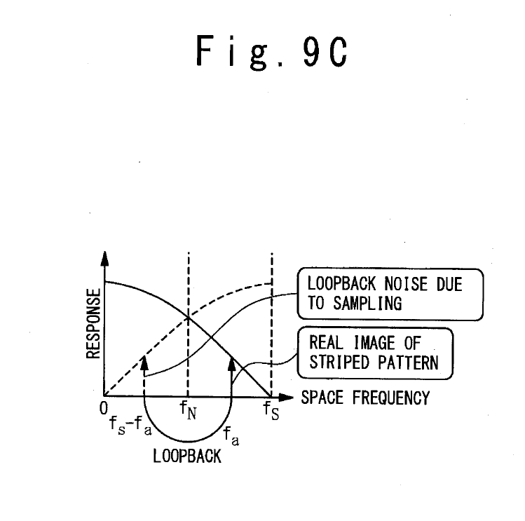

FIGS. 9A, 9B and 9C are diagrams for explaining that apertures of pixels for the same color in the horizontal direction function as a pseudo optical low pass filter and thereby there is no need to use an optical low pass filter. FIG. 9A is a graph showing space frequency dependence of MTF. FIG. 9B is a graph showing appearance of loopback distortion. FIG. 9C is a graph showing interpretation of the loopback distortion with use of the space frequency.

As described in Reference below, when a space frequency representing the number of waves per unit distance (inverse number of a repetition distance of a striped pattern) is denoted by “f” and a pixel pitch is denoted by “p”, a sampling frequency fs and a Nyquist frequency fN (half of fs) that is the upper limit frequency at which a sampled signal can be reproduced are represented as follows.

fs=1/p

fN=1/2p

[Reference] Yonemoto, Kazuya, “Fundamentals and Applications of CCD/CMOS image sensors”, CQ publications, page 247, “A-5 MTF (Modulation Transfer Function) and loopback by sampling of pixel apertures”

Given that the sampling frequency is denoted by “fs”, the pixel aperture width is denoted by “a” and the pixel pitch is denoted by “p”, the MTF is determined on the basis of a pixel aperture ratio “a/p” and a pitch in the striped pattern (relative space frequency “f/fs”). FIG. 9A is a graph showing the relationship. When a fine striped pattern exceeding the Nyquist frequency is imaged, loopback distortion (also referred to as aliasing or moire) centering the sampling frequency fs (f→fs→f) occurs.

FIGS. 9B and 9C are explanatory diagrams using the appearance of the loopback distortion occurring at space frequency components higher than the Nyquist frequency, and the space frequency. In order to prevent such loopback distortion, an actual device such as a camera or a scanner is adapted to include an optical low pass filter to limit light incident on a CCD sensor to the Nyquist frequency or less. In the color CCD linear image sensor 1 according to the present embodiment, the optical low pass filter is not required, and therefore reductions in the chip size and the cost can be achieved.

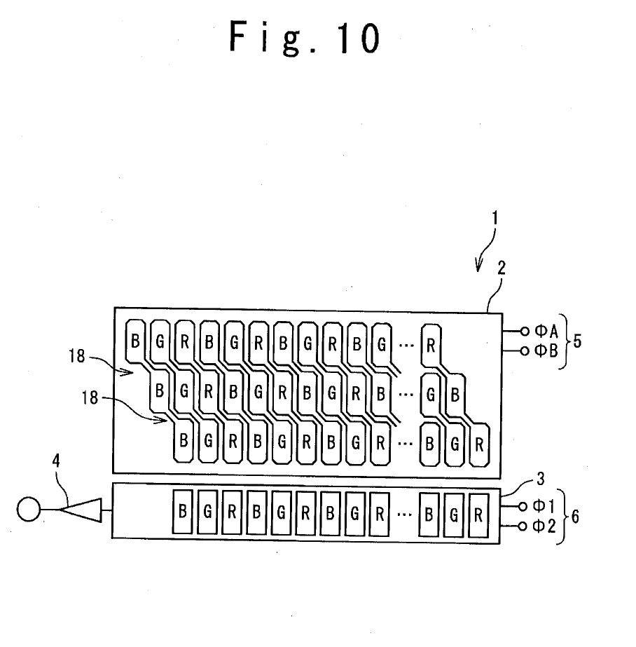

FIG. 10 is a plan view exemplifying the configuration of the color CCD linear image sensor 1 of the above-described first embodiment. Specifically, the color CCD linear image sensor 1 in the first embodiment includes an inter light receiving part transfer part 18 between pixels for the same color. The signal charge transfer between pixels for the same color is performed through the inter light receiving part transfer part 18. The inter light receiving part transfer part 18 transfers the signal charges in accordance with the transfer clocks (light receiving part first and second clocks φA and φB) supplied through the drive clock supply terminals 5. The light receiving part 2 of the color CCD linear image sensor 1 is not limited to the above-described configuration, but may be embodied on the basis of a configuration in which, for example, as in the interline system, a transfer part is provided adjacent to a pixel in the horizontal direction.

### Second Embodiment

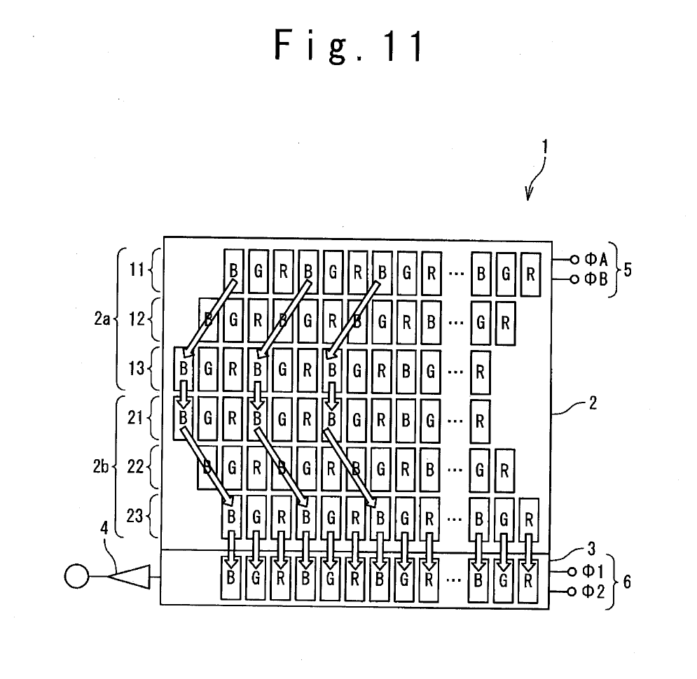

FIG. 11 is a plan view exemplifying a configuration of the color CCD linear image sensor 1 according to a second embodiment of the present invention. In the color CCD linear image sensor 1 of the second embodiment, the light receiving part 2 includes a light receiving part first region 2a and a light receiving part second region 2b. The light receiving part first region 2a corresponds to the first pixel column 11, the second pixel column 12 and the third pixel column 13. The light receiving part second region 2b corresponds to a fourth pixel column 21, a fifth pixel column 22 and a sixth pixel column 23. The color CCD linear image sensor 1 of the second embodiment has the effective aperture 17 similar to that of the color CCD linear image sensor 1 in the first embodiment, and the number of TDI stages of the light receiving part 2 in the horizontal direction is increased. Due to this configuration of the color CCD linear image sensor 1, further improvement in the sensitivity is achieved by an amount corresponding to the increase in the number of stages.

Referring to FIG. 11, the color CCD linear image sensor 1 of the second embodiment has the first, second, third, fourth, fifth and sixth pixel columns 11, 12, 13, 21, 22 and 23 in the scanning direction (vertical direction), wherein pixels for the same color are arranged in the scanning direction (vertical direction) with being displaced one pixel by one pixel in the horizontal direction. Regarding the pixel arrangement in the light receiving part 2, in the light receiving part first region 2a, the pixel rows are arranged from the top stage to the third stage with being displaced leftward one pixel by one pixel. From the third stage to the fourth stage, the pixel rows are arranged in the scanning direction (vertical direction) without being displaced between the light receiving part first and second regions 2a and 2b. In the light receiving part second region 2b, the pixel rows are arranged from the fourth stage to the sixth stage with being displaced rightward one pixel by one pixel.

In the above-described first embodiment, the signal charges of pixels for each of the colors are scanned and added for one pixel through the pixel column in the scanning direction. In the color CCD linear image sensor 1 according to the second embodiment, the signal charges of pixels for each of the colors are scanned and added for the number of pixels (for two pixels in this embodiment) through the pixel column in the scanning direction. The effective aperture 17 having a total size of three pixels in the horizontal direction produces a pseudo effect similar to an effect of an optical low pass filter because of the signal charges for two pixels in the scanning direction.

The color CCD linear image sensor 1 according to the second embodiment has the increased number of pixel columns arranged in the light receiving part 2 as compared with the color CCD linear image sensor 1 in the first embodiment. For this reason, improvement in the sensitivity can be further achieved by an amount corresponding to the increase in the light receiving part 2. Further, if the number of stages to be configured is set to the same number as that in the color CCD linear image sensor 1 of the second embodiment, the signal charges can also be added only, for necessary stages. Based on this, by varying the number of additional pixels in the horizontal direction, the effective aperture 8 can also be varied, as compared with the use of the optical low pass filter of which birefringence characteristic is fixed.

As above, the embodiments of the present invention have been specifically described. However, the present invention is not limited to any of the above-described embodiments, but can be variously modified without departing from the scope thereof.

What is claimed is:

1. A color CCD linear image sensor comprising:
a light receiving part configured to accumulate charges in response to light irradiated; and
a signal charge transfer part configured to read said charges accumulated in said light receiving part and transfer said charges to an output part,
wherein said light receiving part comprises:
a plurality of first basic pixels arranged in a first column and configured to accumulate first-column pixel charges; and
a plurality of second basic pixels arranged in a second column adjacent to said first column and configured to add charges accumulated in response to said light to said first-column pixel charges to generate second-column pixel charges,
wherein said plurality of first basic pixels comprises:
a first-column first-color pixel configured to generate first-column first-color charges associated with a first color;
a first-column second-color pixel arranged adjacent to said first-column first-color pixel and configured to generate first-column second-color charges associated with a second color; and
a first-column third-color pixel arranged adjacent to said first-column second-color pixel and configured to generate first-column third-color charges associated with a third color,
wherein said plurality of second basic pixels comprises:
a second-column first-color pixel configured to generate second-column first-color charges associated with said first color;
a second-column second-color pixel arranged adjacent to said second-column first-color pixel and configured to generate second-column second-color charges associated with said second color; and
a second-column third-color pixel arranged adjacent to said second-column second-color pixel and configured to generate second-column third-color charges associated with said third color, and
wherein said second-column first-color pixel is arranged adjacent to said first-column second-color pixel.

2. The color CCD linear image sensor according to claim 1,
wherein said plurality of first basic pixels further comprises another first-column first-color pixel arranged adjacent to said first-column third-color pixel,
said second-column second-color pixel is arranged adjacent to said first-column third-color pixel,
said second-column third-color pixel is arranged adjacent to said another first-column first-color pixel,
said first-column first-color pixel supplies said first-column first-color charges to said second-column first-color pixel along a third direction different from a row direction,
said first-column second-color pixel supplies said first-column second-color charges to said second-column second-color pixel along said third direction, and
said first-column third-color pixel supplies said first-column third-color charges to said second-column third-color pixel along said third direction.

3. The color CCD linear image sensor according to claim 2,
wherein said light receiving part further comprises: a plurality of third basic pixels arranged in a third column adjacent to said second column and configured to add charges accumulated in response to said light to said second-column pixel charges to generate third-column pixel charges,
wherein said plurality of third basic pixels comprises:
a third-column first-color pixel configured to generate third-column first-color charges associated with said first color;
a third-column second-color pixel arranged adjacent to said third-column first-color pixel and configured to generate third-column second-color charges associated with said second color; and
a third-column third-color pixel arranged adjacent to said third-column second-color pixel and configured to generate third-column third-color charges associated with said third color,
wherein said third-column first-color pixel is arranged adjacent to said second-column second-color pixel in said row direction,
said second-column first-color pixel supplies said second-column first-color charges to said third-column first-color pixel along said third direction,
said second-column second-color pixel supplies said second-column second-color charges to said third-column second-color pixel along said third direction, and
said second-column third-color pixel supplies said second-column third-color charges to said third-column third-color pixel along said third direction.

4. The color CCD linear image sensor according to claim 3,
wherein said third-column second-color pixel is arranged adjacent to said second-column third-color pixel in said row direction,
said third-column third-color pixel is arranged adjacent to another second-column first-color pixel in said row direction, and
said another second-column first-color pixel is arranged adjacent to said second-column third-color pixel along said second column.

5. The color CCD linear image sensor according to claim 4,
wherein said first-column first-color pixel supplies said first-column first-color charges to said second-column first-color pixel at a first time,
said first-column second-color pixel supplies said first-column second-color charges to said second-column second-color pixel at said first time,
said first-column third-color pixel supplies said first-column third-color charges to said second-column third-color pixel at said first time,
said second-column first-color pixel supplies said second-column first-color charges to said third-column first-color pixel at a second time,
said second-column second-color pixel supplies said second-column second-color charges to said third-column second-color pixel at said second time, and
said second-column third-color pixel supplies said second-column third-color charges to said third-column third-color pixel at said second time.

6. The color CCD linear image sensor according to claim 5,
wherein said light receiving part further comprises:
a first charge transfer region provided between said first-column first-color pixel and said second-column first-color pixel;
a second charge transfer region provided between said first-column second-color pixel and said second-column second-color pixel; and
a third charge transfer region provided between said first-column third-color pixel and said second-column third-color pixel.

7. The color CCD linear image sensor according to claim 6,
wherein said light receiving part further comprises:
another first charge transfer region provided between said second-column first-color pixel and said third-column first-color pixel;
another second charge transfer region provided between said second-column second-color pixel and said third-column second-color pixel; and
another third charge transfer region provided between said second-column third-color pixel and said third-column third-color pixel.

8. The color CCD linear image sensor according to claim 3,
wherein said light receiving part comprises:
a first light receiving region; and
a second light receiving region having a plurality of pixels that are line-symmetric with respect to a plurality of pixels arranged in said first light receiving region,
wherein said first light receiving region includes said plurality of first basic pixels, said plurality of second basic pixels and said plurality of third basic pixels.

9. The color CCD linear image sensor according to claim 1,
wherein said first color, said second color and said third color correspond to three primary colors, respectively.
